(19) United States
(12) Patent Application Publication
(10) Pub. No.: US 2022/0028186 A1
(43) Pub. Date: Jan. 27, 2022

(54) VEHICLE IDENTIFICATION NUMBER (VIN)-BASED TELEMATICS DEVICE LOCATION TRACKING

(71) Applicant: Omnitracs, LLC, Dallas, TX (US)

(72) Inventors: Miranda Korin LEADBEATER, Ontario (CA); Jason Lee Palmer, Carlsbad, CA (US)

(21) Appl. No.: 17/381,837

(22) Filed: Jul. 21, 2021

Related U.S. Application Data
(60) Provisional application No. 63/056,384, filed on Jul. 24, 2020.

(51) Int. Cl. G07C 5/00

(52) U.S. Cl. CPC G07C 5/008

(57) ABSTRACT

Aspects of the present disclosure include a recording system that captures vehicle data including a vehicle identification number (VIN) and sensor data, such as odometer readings, positional information of the vehicle, or engine hours of the vehicle, and correlates the VIN to the sensor data. The recording system described herein also compares the VIN to a previously recorded VIN identifying a new VIN to determine whether a change of vehicle has occurred. If no change of vehicle occurred, the recording system may continue to capture data and/or transmit the vehicle data to a management server. If the change of vehicle occurred, the recording system may transmit a notification to one or more devices to alert vehicle tracking personnel (e.g., fleet managers) of the change of vehicle.

### CROSS-REFERNCE TO RELATED APPLICATION

This application claims the benefit of U.S. Provisional Application No. 63/056,384, entitled “VEHICLE IDENTIFICATION NUMBER (VIN)-BASED TELEMATICS DEVICE LOCATION TRACKING” and filed on Jul. 24, 2020, which is expressly incorporated by reference herein in its entirety.

### BACKGROUND

The present disclosure relates generally to a telematics device, and more particularly, to systems and methods of locating a vehicle using vehicle identification number (VIN)-based telematics device location tracking.

An owner of a vehicle or a fleet of vehicles may want to know a current location and/or past locations of the vehicle or fleet of vehicles. Alternatively, or in addition, drivers of some vehicles, such as tractor trailer trucks or delivery trucks, may be required to record their hours-of-service (“HOS”), and or fuel tax application software to comply with transportation regulations and/or company policies. To automate the process of locating/tracking a vehicle and also tracking HOS status and vehicle positions for fuel tax, onboard recorder systems (or telematics systems) may include recording devices to capture data related to corresponding vehicles and drivers. Conventional recorder systems capture data including locations of the vehicles and the odometers of the vehicles as well as HOS codes indicating the driver's HOS status. The captured data may be used to generate driver and/or vehicle logs. However, when a recording device is moved from one vehicle to another vehicle, the captured data may incorrectly reference the old vehicle information for the driver's logs as well as for the vehicle logs.

Accordingly, improvements in onboard recording systems are needed.

### SUMMARY

This summary is provided to introduce a selection of concepts in a simplified form that are further described below in the DETAILED DESCRIPTION. This summary is not intended to identify key features of the claimed subject matter, nor is it intended to be used as an aid in determining the scope of the claimed subject matter.

In an aspect, a method of vehicle location tracking is disclosed. The method may include detecting an activation of a vehicle. The method may include receiving vehicle data including a vehicle identification number (VIN) and sensor data associated with the vehicle in response to the detecting the activation of the vehicle. The method may include correlating the VIN to the sensor data. The method may include determining whether a change of VIN condition occurred based on a comparison of the VIN with a previously recorded VIN identifying a new VIN. The method may include transmitting the vehicle data indicating a correlation of the VIN with the sensor data to a management server in response to the change of VIN condition not occurring. The method may include transmitting a notification to a computing device in response to the change of VIN condition occurring.

In other aspects, an apparatus and a computer-readable medium for performing the methods described herein are disclosed.

Further aspects of the present disclosure are described in more details below.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 is a block diagram of a communication network, according to aspects of the present disclosure;

FIG. 2 is a block diagram of an exemplary vehicle of the system of FIG. 1, including a telematics device, according to aspects of the present disclosure;

FIG. 3 is a process flow diagram of exemplary operations performed by the system of FIG. 1, according to aspects of the present disclosure;

FIG. 4 is a flowchart of an exemplary method, according to aspects of the present disclosure; and

FIG. 5 is a component diagram of an example device used by the system of FIG. 1, according to aspects of the present disclosure.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

Transportation regulations and some company policies may require tracking of vehicle location, such as to know where a vehicle is located and/or where a vehicle has driven. Alternatively, or in addition, transportation regulations and some company policies may require tracking of drivers hours-of-service (“HOS”) and position data for fuel tax applications, such as a number of hours a driver is driving a vehicle in order to meet government HOS regulations for safe driving. To manage the tracking of vehicle location and/or HOS, vehicles may be equipped with recording systems that record data including, locations, mileage, and engine hours of the vehicles, along with corresponding time stamps, driver entered HOS codes, among other things, to track the information for the drivers and the vehicles. The recording systems may include recording devices in communication with vehicle controllers and/or sensors, such as an engine control module (ECM), an engine control unit (ECU), a controller area network (CAN) bus system, a speedometer, tachometer, fuel gauge, scale, odometer, accelerometer, compass, Global Positioning System (“GPS”) receiver, or any other sensor for capturing vehicle data. Typically, the recording systems send the data to a management server, where driver and vehicle logs may be generated.

In some situations, such as during repair or servicing of the vehicles or in the normal course of operating a fleet of vehicles, recording devices are transferred (or moved) from one vehicle to another vehicle. As a result of the transferring of the recording devices between vehicles, some recorded data may be incorrectly associated, as the captured data does not correlate to the vehicle but to the recording device itself

Aspects of the present disclosure include a recording system that captures vehicle data including a vehicle identification number (VIN) and sensor data, such as odometer readings, positional information of the vehicle, or engine hours of the vehicle, and correlates the VIN to the sensor data to accurately locate a vehicle. The recording system described herein also compares the VIN to a previously recorded VIN to determine whether a change of vehicle has occurred. If no change of vehicle occurred, the recording system may continue to capture data and/or transmit the vehicle data to a management server. If the change of vehicle occurred, the recording system may automatically be configured with one or more parameters corresponding to a new vehicle and/or transmit a notification to one or more devices to alert vehicle tracking personnel (e.g., fleet managers) of the change of vehicle.

The comparison of the VINs may ensure sensor data correlates to the correct vehicle thereby avoiding, for example, incorrect database data, driver logs, and/or vehicle logs, and allow a recording device to be automatically configured for communication with components (e.g., sensors) of a new vehicle. Further, the comparison of the VINs may allow management personnel to update (or correct) the database to show the correlation of sensor data to the correct vehicles and/or return the recording devices to the correct vehicles, if these devices were transferred in error.

Turning now to the figures, example aspects are depicted with reference to one or more components described herein, where components in dashed lines may be optional.

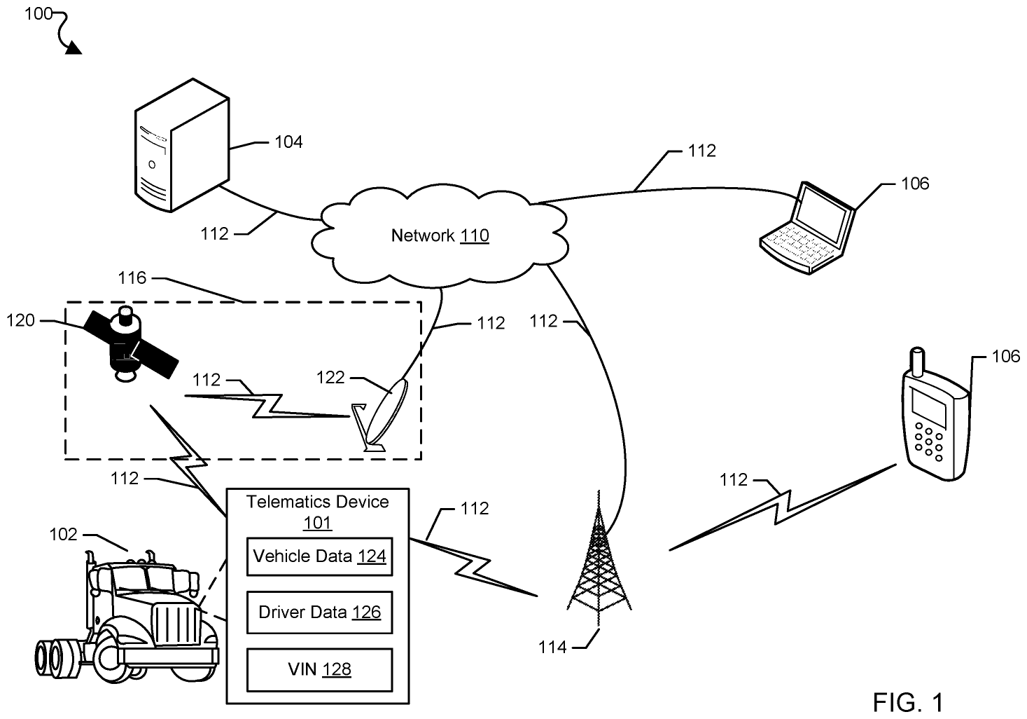

Referring to FIG. 1, an example vehicle telematics system 100 for accurately identifying and/or tracking a vehicle location is depicted. The vehicle telematics system 100 may include a telematics device 101 removably associated with a vehicle 102, such as a tractor trailer truck or a cargo truck, in communication with a management server 104 through a communications network 110. Examples of the communications network 110 may include one or more terrestrial and/or satellite networks, including networks such as an intranet or the Internet.

The vehicle 102 may communicate via one or more communications links 112 including wireless communications links or wired communications links. In an example, wireless communications links 112 may exchange data via an access point or base station 114 using one or more cellular communications technologies such as code division multiple access (CDMA) technologies, time division multiple access (TDMA) technologies, personal communications service (PCS) technologies, and 3rd Generation Partnership Project (3GPP) technologies (e.g., fourth generation (4G), fifth generation (5G), long term edition (LTE) technologies), a Wi-Fi technology, a Bluetooth technology, or any other wireless communication technologies. Alternatively, or in addition to cellular or Wi-Fi or Bluetooth communications technologies, the wireless communications links 112 may exchange data via a satellite communication system 116 including one or more satellites 120 and one or more receiver dishes 122 using one or more satellite communications technologies. Both the access points or the base station 114 and the satellite communications system 116 may be communicatively coupled to the network via, for example, wired communications links 112 which may include one or more cables and or fiber optics for transferring data.

The management server 104 may store information for all vehicles and drivers associated with the vehicle telematics system 100. In an example, the management server 104 may receive a VIN from the vehicle 102, and may determine, based on the VIN, vehicle information, including, but not limited to, make and model of the vehicle 102 and/or component configuration of the vehicle 102. Based on the vehicle information, the management server 104 may generate configuration information for configuring the telematics device 101 to communicate with one or more components of the vehicle 102. In an example, the configuration information may include information for configuring the telematics device 101 to communicate and/or interpret data with the one or more components (e.g., sensors 220) of the vehicle 102 and/or include information for configuring the telematics device 101 to alert a driver and/or another person when one or more vehicle parameters (e.g., speed rating, engine temperature) specific to the vehicle 102 are not within a threshold. The management server 104 may transmit the configuration information to the vehicle 102 to configure the telematics device 101.

The vehicle telematics system 100 may also include one or more management devices 106 used to receive communications from the vehicle 102 and/or the management server 104, as described herein. Examples of the management devices106 may include computing devices, such as mobile devices (e.g., cellular phones, smartphones, or personal digital assistants (PDAs)), laptops, tablets, or personal computers, used by personnel for monitoring the vehicle telematics system 100. The management devices 106 may communicate with the network 110 via the communications links 112.

In an example, the vehicle 102 may obtain and transmit vehicle data 124 and/or driver data 126, including VIN information 128 correlated with such data, to the management server 104 for identifying a current location of the vehicle, for tracking historical vehicle location information (e.g., for determining mileage driven in a given jurisdiction), and/or for generating driver logs and vehicle logs for compliance with transportation regulations or company policies.

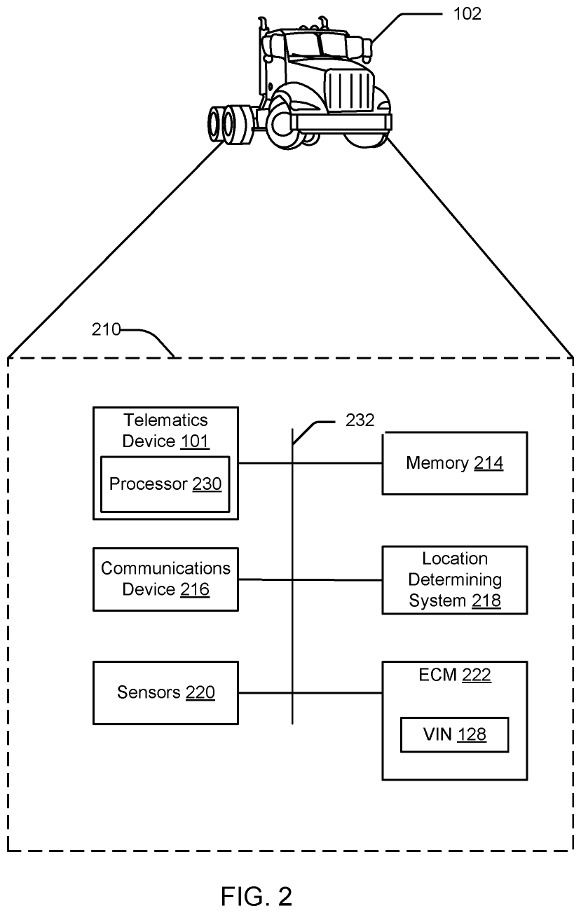

Referring to FIG. 2, an example of a recording system 210 incorporated by the vehicle 102 is depicted. The recording system 210 may include a telematics device 101 including one or more processors 230 that, along with memory 214, communicate to effectuate certain functions or actions, as described herein. The one or more processors 230 may be configured to execute instructions or code stored on the memory 214. In an implementation, the instructions or code may include instructions or code for obtaining and providing the vehicle data 124 and/or the driver data 126 and associated VIN information 128, as described herein.

The recording system 210 may also include a communications device 216, which may include substantially any wired or wireless device, or related modem, etc., for providing wired or wireless communications utilizing various protocols to send/receive electronic signals internally to features and systems within the vehicle 102 and/or to external devices including the management server 104 and/or management devices 106. In an example, the communications device 216 may communicate using one or more radio technologies (e.g.,3GPP radio access technologies, IEEE 802.11, or Bluetooth®).

The recording system 210 may also include a location determining system 218 for determining a location-related parameters of the vehicle 102. For example, the location determining system 218 may determine one or more location-related parameters, such as location, position, speed, acceleration, and direction, among other parameters, of the vehicle 102. In some examples, the location determining system 218 may include or may be communicatively coupled with a global positioning system (“GPS”) device (or other latitude/longitude determination device), a speedometer, an accelerometer, a gyroscope, and/or the like, to determine the location-related parameters.

The recording system 210 may also include sensors 220 mounted on the vehicle 102. The sensors 220 may capture data related to one or more aspects of the vehicle including an odometer reading a distance traveled, engine hours, vehicle temperature, vehicle speed from a speedometer, vehicle acceleration from an accelerometer, vehicle orientation from a gyroscope, etc. For aspects of the present disclosure, data from the sensors 220 and data from the location determining system 218 are referred to as sensor data and/or vehicle data.

The recording system 210 may also include an engine control module (ECM) 222 (and/or ECU and/or CAN bus system) for monitoring the sensors 220. The ECM 222 may provide alerts to a driver of the vehicle 102, based on input from the sensors 220. Further, the ECM 222 may store the VIN information 128 of the vehicle 102.

The telematics device 101 may manage vehicle location data and HOS data collection and reporting to the management server 104. In an example, the telematics device 101 may store previously received data, obtain new data from any of the other components of the recording system 210, and report the data to the management server 104. As described herein, the telematics device 101 may also report a change of vehicles to one or more of the management devices 106, when, for example, the telematics device 101 has been removed from a first vehicle and installed in the vehicle 102 (e.g., second vehicle) based on the telematics device 101 detecting a change in the VIN information 128.

In an aspect, if a change in vehicles is determined, the telematics device 101 may communicate with the the management server 104 to receive configuration information to configure the telematics device 101 to communicate with one or more components of the vehicle 102 and/or provide alerts to the management device 106 and/or a driver of the vehicle 102. In an example, the configuration information may contain information to configure the telematics device 101 to interpret data from the sensors 220. In another example, the configuration information may contain information to configure the telematics device 101 according to one or more vehicle parameters. For example, the configuration information may include speed rating data (such as recommended vehicle speed per guidelines and vehicle type) corresponding to the vehicle 102. Accordingly, the configuration information may include parameters and/or thresholds for determining when to alert the driver (or another individual) of a speed rating being exceeded.

In some examples, the various components of the recording system 210 may be operably coupled to one another via one or more busses 232 to facilitate communication among the components to perform functions described herein. Moreover, one or more of the components described for the recording system 210 may be part of another system. For example, one or more of the memory 214, the communications device 216, the location determining system 218, the sensors 220, or the ECM 222 may be part of or used by one or more of a navigation system or safety system of the vehicle 102.

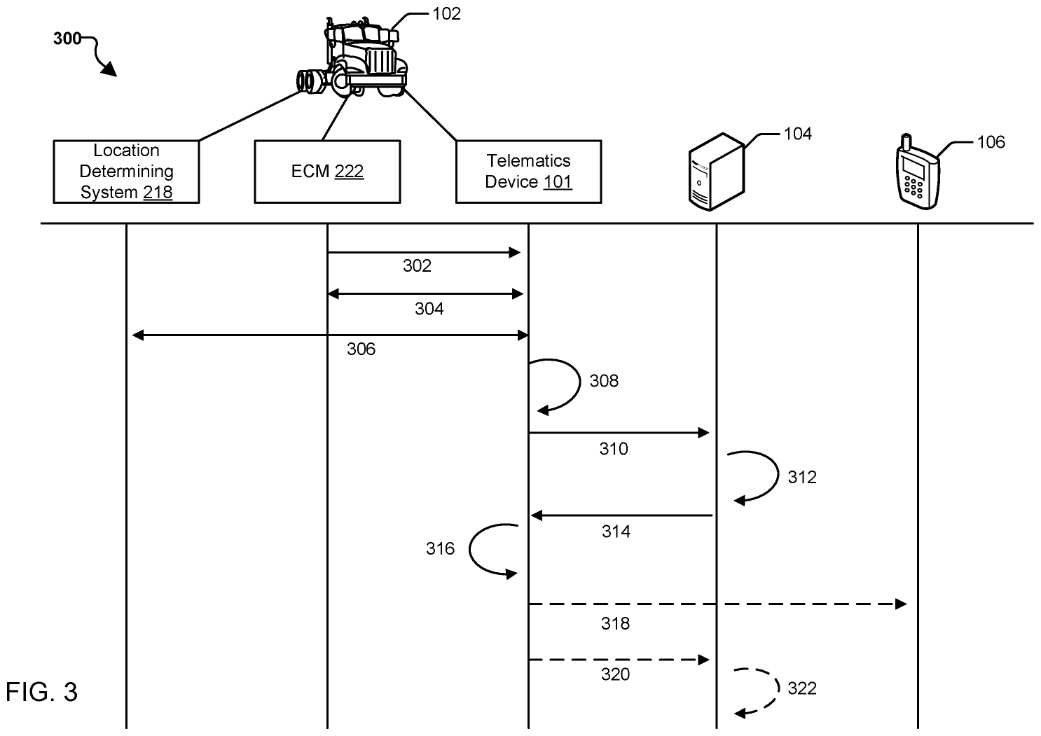

Referring to FIG. 3, an example process flow 300 illustrating communications of the recording system 100 is depicted. At operation 302, the ECM 222 may indicate to the telematics device 101 that startup of the vehicle 102 has occurred. Alternatively, the telematics device 101 may determine startup of the vehicle 102 has occurred when, for example, the telematics device 101 is activated (e.g., power received from electrical system of vehicle 102). At operations 304 and 306, the telematics device 101 may communicate with the ECM 222 and the location determining system 218 to obtain vehicle data. For example, the telematics device 101 may request for and obtain the VIN information 128 of the vehicle 102 and odometer data from the ECM 222 and the location of the vehicle 102 from the location determining system 218. Alternatively, or additionally, this data or additional data (e.g., engine hours) may be obtained from the ECM 222 or one or more of the sensors 220.

At operation 308, the telematics device 101 may compare newly received data to stored data to determine whether the telematics device 101 has changed vehicles since a last indication of a startup of a vehicle. For example, the telematics device 101 may compare the newly received VIN to a previously recorded VIN to determine whether a change in vehicles occurred.

At operation 310, the telematics device 101 may transmit an indication of a correlation of the VIN with the sensor data to the management server 104 in response to no change in vehicles being determined by the telematics device 101. At operation 312, the management server 104 may generate one or more driver logs or vehicle logs based on the received vehicle data.

Alternatively, at the operation 310, the telematics device 101 may transmit an indication of the change of VIN condition with the VIN to the management server 104 in response to the change of VIN condition occurring. In an example, the indication may include the VIN information 128 of the vehicle 102. In reponse to receiving the indication, at operation 312, the management server 104 may generate configuration information, as described herein, for configuring the telematics device 101 to communicate with one or more components of the vehicle 102, and, at operation 314, send the configuration information to the telematics device 101. At operation 316, the telematics device 101 may be configured according to the configuration information.

Alternatively or in addition, at operation 318, the telematics device 101 may transmit a notification to one or more management devices 106 in response to determining a change in vehicles occurred. The notification may indicate to the management devices 106 that the telematics device 101 has changed from a first vehicle to the vehicle 102. Further the notification may include the VINs of the vehicles (e.g., previous vehicle with the telematics device 101 and vehicle 102 (current vehicle with telematics device 101)). Examples of the notification may include a text message, an email, an application notification, an instant message, a pre-recorded voice message, or any other form of communication to notify a user of a management device 106.

Alternatively, or in addition to transmitting the notification to the management device 106, at operation 320, the telematics device 101 may transmit the notification to the management server 104. In response to the notification, at operation 322, the management server 104 may correct any errors to the database based on the change in the vehicles, e.g., such as by associating the new VIN information 128 with the corresponding vehicle data 124 and/or driver data 126 of the new vehicle.

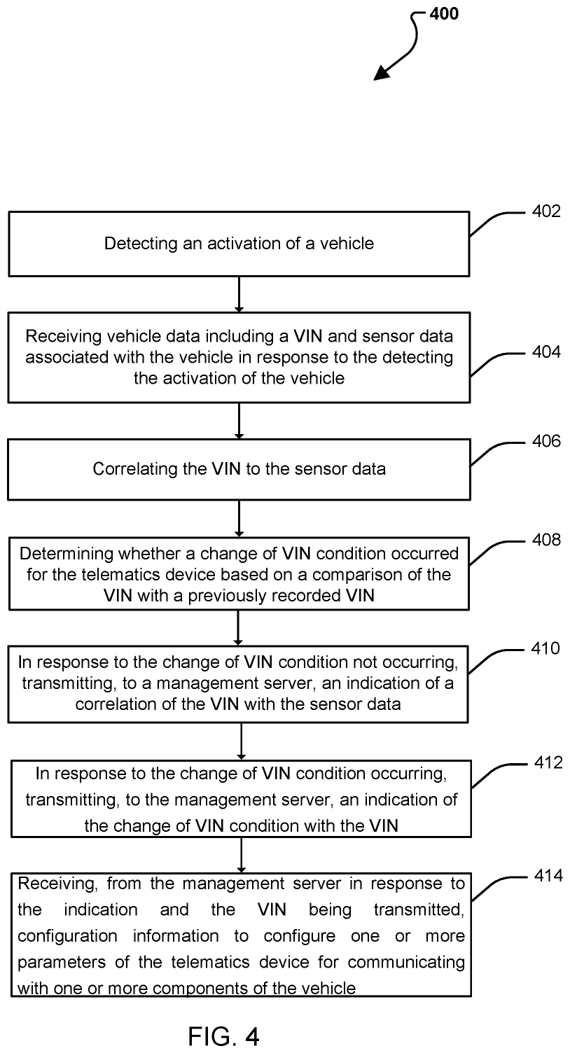

Referring to FIG. 4, a method 400 according to aspects of the present disclosure is shown therein. In an example, the method 400 may be performed by one or more components (e.g., processor 230) of the telematics device 101 of FIG. 2. At block 402, the method 400 may include detecting an activation of a vehicle. For example, the processor 230 may detect an activation of the vehicle 102 in response to a received signal from the ECM 222 (e.g., operation 302 of FIG. 2) or in response to receiving power from the vehicle 102.

At block 404, the method 400 may include receiving vehicle data including a VIN and sensor data associated with the vehicle in response to the detecting the activation of the vehicle. For example, the processor 230 may communicate with the ECM 222 and/or one or more components (e.g., location determining system 218 or sensors 220) of the recording system 210, as illustrated by operations 304 and 306 of FIG. 3, in response to activation of the vehicle 102. Based on the communications, the processor 230 may obtain the VIN information 128 of the vehicle 102 and vehicle data 124, including the sensor data from the sensors 220. In an example, the received data may be stored in, for example, the memory 214.

At block 406, the method 400 may include correlating the VIN to the sensor data. For example, the processor 230 may correlate the VIN to the sensor data by linking this data together in, for example, a database of the memory 214.

At block 408, the method 400 may include determining whether a change of VIN condition occurred for the telematics device based on a comparison of the VIN with a previously recorded VIN. For example, the processor 230 may compare the VIN information 128 of the vehicle 102 with a previously received VIN information stored in the memory 214 to determine whether a change of VIN condition occurred, as illustrated by operation 308 of FIG. 3.

At block 410, the method 400 may include transmitting, to a management server, an indication of a correlation of the VIN with the sensor data in response to the change of VIN condition not occurring. For example, the processor 230 may transmit the vehicle data indicating a correlation of the VIN with the sensor data to the management server 104 in response to the change of VIN condition not occurring, as illustrated by operation 310.

At block 412, the method 400 may include transmitting, to the management server, an indication of the change of VIN condition with the VIN in response to the change of VIN condition occurring. For example, the processor 230 may transmit the indication, as illustrated by operation 310 of FIG. 3, to one or more of the management devices 106 in response to the change of VIN condition occurring.

At block 414, the method 400 may include receiving, from the management server in response to the indication and the VIN being transmitted, configuration information to configure one or more parameters of the telematics device for communicating with one or more components of the vehicle. For example, the processor 230 may receive the configuration information, as illustrated by operation 314 of FIG. 3, from the management server 104.

In an aspect, the method 400 may further include transmitting, in response to the change of VIN condition occurring, a notification to a computing device indicating the change of VIN condition. For example, the vehicle 102, the telematics device 101, or the processor 230 may transmit, in response to the change of VIN condition occurring, a notification to a computing device indicating the change of VIN condition, as illustrated by operation 318 of FIG. 3.

In an aspect of method 400, the sensor data includes data from one or more of a odometer, a location determining system, or an engine hours tracker

In an aspect, the method 400 may further include receiving the vehicle data from an engine control module (ECM) of the vehicle. For example, the vehicle 102, the telematics device 102, or the processor 230 may receive the vehicle data from an engine control module (ECM) of the vehicle, as illustrated by operation 302 of FIG. 3.

In an aspect, the method 400 may further include maintaining a database of vehicle information including previously received vehicle data, and adding the vehicle data to the database.

In an aspect, in method 400, the receiving of the vehicle data including the VIN and the sensor data associated with the vehicle includes receiving vehicle location information from a location determining system, and the correlating of the VIN to the sensor data includes correlating the VIN to the vehicle location information. For example, such correlation may be used to accurately track a current location of the vehicle, or to track historical locations of the vehicle (e.g., such as for tracking mileage in a jurisdiction).

In an aspect, the method 400 may further include configuring the one or more parameters of the telematics device for communicating with the one or more components of the vehicle, based on the configuration information. For example, the vehicle 102, the telematics device 102, or the processor 230 may configure the one or more parameters of the telematics device 101 for communicating with the one or more components of the vehicle 102, based on the configuration information, as illustrated by operation 316 of FIG. 3.

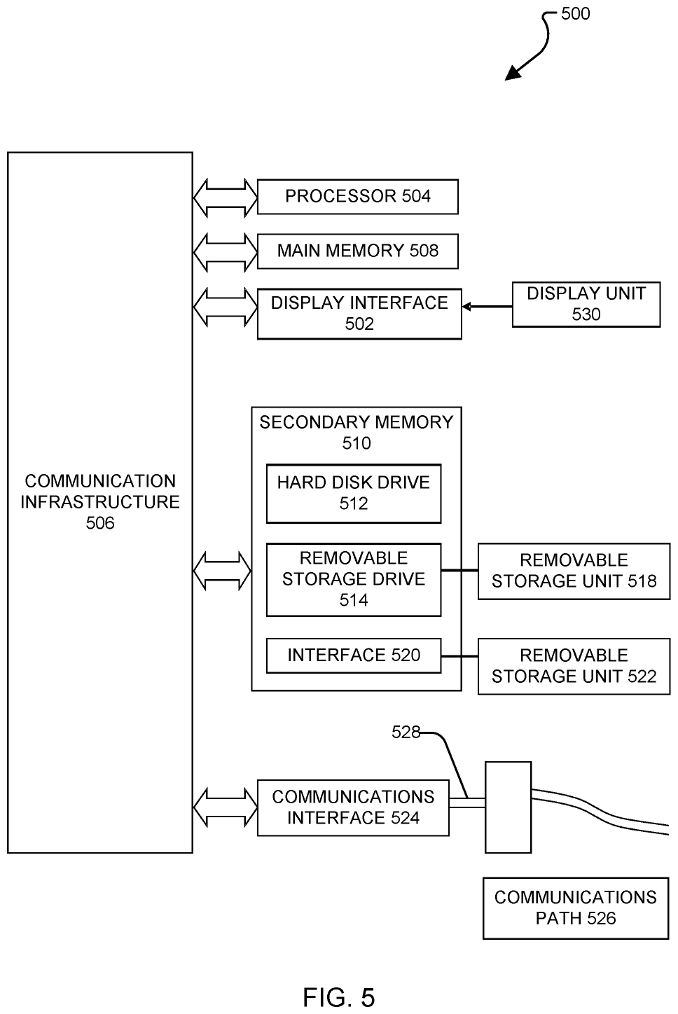

Referring to FIG. 5, an example system is presented with a diagram of various hardware components and other features, for use in accordance with an aspect of the present disclosure. Aspects of the present disclosure may be implemented using hardware, software, or a combination thereof and may be implemented in one or more computer systems or other processing systems. In one example variation, aspects described herein may be directed toward one or more computer systems capable of carrying out the functionality described herein. An example of such a computer system 500 is shown in FIG. 5. The computer system 500 may be an example of any one of the telematics device 101, the management server 104, or the management device 106.

The computer system 500 may include one or more processors, such as processor 504. The processor 504 is connected to a communication infrastructure 506 (e.g., a communications bus, cross-over bar, or network). The processor 504 may be an example of the processor 230. Various software aspects are described in terms of this example computer system 500. After reading this description, it will become apparent to a person skilled in the relevant art(s) how to implement aspects described herein using other computer systems and/or architectures.

The computer system 500 may include a display interface 502 that forwards graphics, text, and other data from the communication infrastructure 506 (or from a frame buffer not shown) for display on a display unit 530. The computer system 500 may also include a main memory 508, e.g., random access memory (RAM), and may also include a secondary memory 510. The secondary memory 510 may include, e.g., a hard disk drive 512 and/or a removable storage drive 514, representing a floppy disk drive, a magnetic tape drive, an optical disk drive, etc. The removable storage drive 514 may read from and/or write to a removable storage unit 518 in a well-known manner. The removable storage unit 518, represents a floppy disk, magnetic tape, optical disk, etc., which is read by and written to the removable storage drive 514. As will be appreciated, the removable storage unit 518 may include a computer usable storage medium having stored therein computer software and/or data.

In alternative aspects, the secondary memory 510 may include other similar devices for allowing computer programs or other instructions to be loaded into the computer system 500. Such devices may include, e.g., a removable storage unit 522 and an interface 520. Examples of such may include a program cartridge and cartridge interface (such as that found in video game devices), a removable memory chip (such as an erasable programmable read only memory (EPROM), or programmable read only memory (PROM)) and associated socket, and other removable storage units 522 and interfaces 520, which allow software and data to be transferred from the removable storage unit 522 to the computer system 500. The memory 214 may include one or more of the main memory 508, the secondary memory 510, the removable storage drive 514, the removable storage unit 518, or the removable storage unit 522.

The computer system 500 may also include a communications interface 524. The communications interface 524 may allow software and data to be transferred between the computer system 500 and external devices. Examples of the communications interface 524 may include a modem, a network interface (such as an Ethernet card), a communications port, a Personal Computer Memory Card International Association (PCMCIA) slot and card, etc. Software and data transferred via communications interface 524 are in the form of signals 528, which may be electronic, electromagnetic, optical or other signals capable of being received by the communications interface 524. These signals 528 are provided to the communications interface 524 via a communications path (e.g., channel) 526. This path 526 carries signals 528 and may be implemented using wire or cable, fiber optics, a telephone line, a cellular link, a radio frequency (RF) link and/or other communications channels. The terms “computer program medium” and “computer usable medium” are used to refer generally to media such as a removable storage drive, a hard disk installed in a hard disk drive, and/or signals 528. These computer program products provide software to the computer system 500. Aspects described herein may be directed to such computer program products. In an example, the communications device 216 may include the communications interface 524.

Computer programs (also referred to as computer control logic) may be stored in the main memory 508 and/or the secondary memory 510. The computer programs may also be received via the communications interface 524. Such computer programs, when executed, enable the computer system 500 to perform various features in accordance with aspects described herein. In particular, the computer programs, when executed, enable the processor 504 to perform such features. Accordingly, such computer programs represent controllers of the computer system 500. The computer programs may include instructions or code for executing one or more operations of FIG. 2 and/or the method of FIG. 3.

In variations where aspects described herein are implemented using software, the software may be stored in a computer program product and loaded into the computer system 500 using the removable storage drive 514, the hard disk drive 512, or the communications interface 520. The control logic (software), when executed by the processor 504, causes the processor 504 to perform the functions in accordance with aspects described herein. In another variation, aspects are implemented primarily in hardware using, e.g., hardware components, such as application specific integrated circuits (ASICs). Implementation of the hardware state machine so as to perform the functions described herein will be apparent to persons skilled in the relevant art(s).

In yet another example variation, aspects described herein are implemented using a combination of both hardware and software.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (“DSP”), an application specific integrated circuit (“ASIC”), a field programmable gate array (“FPGA”) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary aspects, the functions described may be implemented in hardware, software, firmware, or any combination thereof If implemented in software, the functions may be stored on or transmitted over as one or more instructions or code on a computer-readable medium. The steps of a method or algorithm disclosed herein may be embodied in a processor-executable software module which may reside on a tangible, non-transitory computer-readable storage medium. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory machine readable medium and/or computer-readable medium, which may be incorporated into a computer program product.

The word “exemplary” is used herein to mean “serving as an example, instance, or illustration.” Any implementation described herein as “exemplary” is not necessarily to be construed as preferred or advantageous over other implementations.

As used herein, the term “mobile device” is used interchangeably herein to refer to any one or all of cellular telephones, smartphones, personal or mobile multi-media players, personal data assistants (PDA' s), personal computers, laptop computers, tablet computers, smart books, palm-top computers, wireless electronic mail receivers, multimedia Internet enabled cellular telephones, wireless gaming controllers, in vehicle displays, computer kiosks, and similar personal electronic devices which include a programmable processor and memory and circuitry for receiving driver input, displaying a web browser, and connecting to the Internet.

The term “vehicle,” as used herein, may refer to any moving vehicle that is capable of carrying one or more human occupants. The term “vehicle” may include, but is not limited to: cars, trucks, vans, minivans, sport-utility vehicles (SUVs), aircrafts, or tractor trailer trucks.

As used herein, the term “onboard vehicle recording device” is used to refer to devices onboard a vehicle that are configured to receive sensor inputs of various vehicle sensors and provide vehicle performance data to another device off-board the vehicle. In an embodiment, an onboard vehicle recording device may be a standalone device. In another embodiment, an onboard vehicle recording device may be integrated with another device, such as an engine computer/controller. In an embodiment, the onboard vehicle recording device may connect to the vehicle data bus to capture, process, store, and transmit vehicle data.

The term “bus,” as used herein, may refer to an interconnected architecture that is operably connected to transfer data between computer components within a singular or multiple systems. The bus may be a memory bus, a memory controller, a peripheral bus, an external bus, a crossbar switch, and/or a local bus, among others. The bus may also be a vehicle bus that interconnects components inside a vehicle using protocols such as Controller Area Network (CAN), Local Interconnect Network (LIN), among others.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method of vehicle location tracking by a telematics device, comprising:
detecting an activation of a vehicle;
receiving vehicle data including a vehicle identification number (VIN) and sensor data associated with the vehicle in response to the detecting the activation of the vehicle;
correlating the VIN to the sensor data;
determining whether a change of VIN condition occurred for the telematics device based on a comparison of the VIN with a previously recorded VIN;
in response to the change of VIN condition not occurring, transmitting, to a management server, an indication of a correlation of the VIN with the sensor data ; and
in response to the change of VIN condition occurring,
transmitting, to the management server, an indication of the change of VIN condition with the VIN; and
receiving, from the management server in response to the indication and the VIN being transmitted, configuration information to configure one or more parameters of the telematics device for communicating with one or more components of the vehicle.

2. The method of claim 1, further comprising:
transmitting, in response to the change of VIN condition occurring, a notification to a computing device indicating the change of VIN condition.

3. The method of claim 1, wherein the sensor data includes data from one or more of a odometer, a location determining system, or an engine hours tracker.

4. The method of claim 1, further comprising:
receiving the vehicle data from an engine control module (ECM) of the vehicle.

5. The method of claim 1, further comprising:
maintaining a database of vehicle information including previously received vehicle data; and
adding the vehicle data to the database.

6. The method of claim 1, wherein receiving the vehicle data including the VIN and the sensor data associated with the vehicle includes receiving vehicle location information from a location determining system, and wherein correlating the VIN to the sensor data includes correlating the VIN to the vehicle location information.

7. The method of claim 1, further comprising:
configuring the one or more parameters of the telematics device for communicating with the one or more components of the vehicle, based on the configuration information.

8. A telematics device for a vehicle, comprising:
a memory storing instructions; and
one or more processors coupled with the memory and configured to:
detect an activation of a vehicle;
receive vehicle data including a vehicle identification number (VIN) and sensor data associated with the vehicle in response to the activation of the vehicle being detected;
correlate the VIN to the sensor data;
determine whether a change of VIN condition occurred for the telematics device based on a comparison of the VIN with a previously recorded VIN;
in response to the change of VIN condition not occurring, transmit, to a management server, an indication of a correlation of the VIN with the sensor data ; and
in response to the change of VIN condition occurring,
transmit, to the management server, an indication of the change of VIN condition with the VIN; and
receive, from the management server in response to the indication and the VIN being transmitted, configuration information to configure one or more parameters of the telematics device for communicating with one or more components of the vehicle.

9. The telematics device of claim 8, wherein the one or more processors is further configured to:
transmit, in response to the change of VIN condition occurring, a notification to a computing device indicating the change of VIN condition.

10. The telematics device of claim 8, wherein the sensor data includes data from one or more of a odometer, a location determining system, or an engine hours tracker.

11. The telematics device of claim 8, wherein the one or more processors is further configured to:
receive the vehicle data from an engine control module (ECM) of the vehicle.

12. The telematics device of claim 8, wherein the one or more processors is further configured to:
maintain a database of vehicle information including previously received vehicle data; and
add the vehicle data to the database.

13. The telematics device of claim 8, wherein the one or more processors is further configured to:
receive vehicle location information from a location determining system, and
correlate the VIN to the vehicle location information.

14. The telematics device of claim 8, wherein the one or more processors is further configured to:
configure the one or more parameters of the telematics device for communicating with the one or more components of the vehicle, based on the configuration information.

15. A computer-readable medium for a telematics device, comprising computer executable instructions to:
detect an activation of a vehicle;
receive vehicle data including a vehicle identification number (VIN) and sensor data associated with the vehicle in response to the activation of the vehicle being detected;
correlate the VIN to the sensor data;
determine whether a change of VIN condition occurred for the telematics device based on a comparison of the VIN with a previously recorded VIN;
in response to the change of VIN condition not occurring, transmit, to a management server, an indication of a correlation of the VIN with the sensor data ; and
in response to the change of VIN condition occurring,
transmit, to the management server, an indication of the change of VIN condition with the VIN; and
receive, from the management server in response to the indication and the VIN being transmitted, configuration information to configure one or more parameters of the telematics device for communicating with one or more components of the vehicle.

16. The computer-readable medium of claim 15, further comprising computer executable instructions to:
transmit, in response to the change of VIN condition occurring, a notification to a computing device indicating the change of VIN condition.

17. The computer-readable medium of claim 15, wherein the sensor data includes data from one or more of a odometer, a location determining system, or an engine hours tracker.

18. The computer-readable medium of claim 15, further comprising computer executable instructions to:
receive the vehicle data from an engine control module (ECM) of the vehicle.

19. The computer-readable medium of claim 15, further comprising computer executable instructions to:
maintain a database of vehicle information including previously received vehicle data; and
add the vehicle data to the database.

20. The computer-readable medium of claim 15, further comprising computer executable instructions to:
configure the one or more parameters of the telematics device for communicating with the one or more components of the vehicle, based on the configuration information.
